(19) United States
(12) Patent Application Publication
(10) Pub. No.: US 2022/0357719 A1
(43) Pub. Date: Nov. 10, 2022

(54) AUTOMATED VISION-BASED SYSTEM FOR TIMING DRAINAGE OF SAND IN FLOWBACK PROCESS

(71) Applicant: ROYCO ROBOTICS, Austin, TX (US)

(72) Inventors: Cole Stout, Austin, TX (US); Suman Deb Roy, New York, NY (US)

(21) Appl. No.: 17/662,717

(22) Filed: May 10, 2022

Related U.S. Application Data
(60) Provisional application No. 63/186,401, filed on May 10, 2021.

(51) Int. Cl. G05B 19/416; G06T 7/00; G05D 7/06; G01J 5/00; G01J 5/80

(52) U.S. Cl. CPC G05B 19/416; G06T 7/0004; G05D 7/0623; G01J 5/0037; G01J 5/80; G06T 2207/10048; G06T 2207/30164; E21B 43/35

(57) ABSTRACT

An automated computer-vision system is used for timing the sand drainage in a sand management arrangement that handles flowback of sand and other solid materials in a slurry of flow from well(s) at wellsite(s). The automated system uses infrared imaging of flowback equipment to determine a level of solids (sand) in the equipment. Image processing of the temperature differences of the content in the equipment gives a demarcation of the sand and liquid separation in the equipment, which is used to determine how much sand is present. If the equipment is found to be full or above a predefined benchmark, the automated system operates a discharge skid to discharge the contents to a waste tank.

### CROSS-REFERENCE TO RELATED APPLICATIONS

This application claims the benefit of U.S. Provisional Appl. No. 63/186,401 filed May 10, 2021, which is incorporated herein by reference in its entirety.

### FIELD OF THE DISCLOSURE

The present disclosure is directed to an automated vision-based system for monitoring and draining flowback equipment in a sand management arrangement at a wellsite. The system uses computer vision technology to understand and predict ideal or opportune times to discharge sand from the flowback equipment.

### BACKGROUND OF THE DISCLOSURE

Sand is often present in oil and gas production and can cause different kinds of problems and capital loss to the downstream processes and equipment if not disposed of properly. Especially with the advent of fracture processes, sand separation and drainage has become not only a typical but critical process for every well. Wellsites can use various types of systems to handle flowback of sand from wellbores. For example, cyclones, separators, and filters can be set up at the wellsite to handle sand contained in the flow from the wells. The sand can be naturally produced from the well or may come from previous fracturing operations. Either way, the sand and other solid and semi-solid material including sludge can be produced over many production phases from the wells, and operators need to handle the sand in an environmentally responsible way.

Various types of digital sensors and data are used with the flowback equipment of the cyclones, separators, and filters to monitor operations. For example, sensors can monitor pressure for the filters. Sensors can measure the sand for the cyclones. Blowdown vessels can have sensors to monitor the volume of sand. Although these systems are helpful in monitoring the operation of the flowback hardware and ensuring that sand and solids are efficiently separated from well fluids, they require direct integration in the flowback equipment. Because the operators often rent flowback equipment from other providers on a rolling basis, any new direct integration can be costly in terms of parts acquisition, assembly and maintenance—leading to increased costs.

Finally, a manual process is used to actually discharge and dump the waste materials of sand and other solids into a tank, such as a discharge container that can be evacuated or hauled away. For example, a common way to drain sand collected in any type of sand separation vessel is by manually operating the drainage valves. This manual operation has a heavy dependence on manpower. Due to the unpredictable sand production and accumulation in the sand separation vessel given that wells are subject to unforeseeable subsurface phenomena, automated forms of drainage systems have to operate under quick periodic cycles to avoid the unnecessary heavy sand accumulation and any blockage of the drainage outlet. If such a block happens, it can cause energy loss and the waste of valve service longevity and hold up operation together with causing unnecessary servicing costs. This form of periodic operation increases energy costs due to the repeated opening/closing valves and operation of hydraulic systems. In the worst case, a damaged valve can shut down production, costing a company millions of dollars.

The subject matter of the present disclosure is directed to overcoming, or at least reducing the effects of, one or more of the problems set forth above.

### BRIEF DESCRIPTION OF THE DRAWINGS

FIG. 1 illustrates a schematic plan view of a sand management arrangement according to the present disclosure for disposal of sand in a flowback process.

FIG. 2 illustrates a schematic view of an automated system for monitoring and draining sand in the sand management arrangement.

FIG. 3 illustrates a schematic view of infrared measurements of the automated system in timing the drainage of sand from flowback equipment.

FIG. 4 illustrates a flow chart of a process for timing the drainage of sand in the flowback process.

### SUMMARY OF THE DISCLOSURE

A method is disclosed of monitoring and timing the operating procedure of flowback equipment that receives discharge slurry of liquid and solid particulate at a wellsite. The method comprises: obtaining infrared image information of the flowback equipment using one or more infrared-enabled cameras; monitoring temperature values at a plurality rangefinder points in the infrared image information; determining a demarcation between the solid particulate and the liquid in the flowback equipment based on the monitored temperature values; estimating from the demarcation an amount of the flowback equipment filled by the solid particulate; and instructing drainage of the flowback equipment based on the estimated amount.

A system disclosed herein is used with flowback equipment at a wellsite. The system comprises: one or more cameras, communication equipment, and processing equipment. One or more cameras are configured to image infrared radiation of the flowback equipment, and the communication equipment is configured to communicate information.

The processing equipment is disposed in communication with the one or more cameras and the communication equipment. The processing equipment is configured to: obtain infrared image information of the flowback equipment using the one or more infrared-enabled cameras; monitor temperature values at a plurality rangefinder points in the infrared image information; determine a demarcation between the solid particulate and the liquid in the flowback equipment based on the monitored temperature values; estimate from the demarcation an amount of the flowback equipment filled by the solid particulate; and instruct drainage of the flowback equipment based on the estimated amount.

The foregoing summary is not intended to summarize each potential embodiment or every aspect of the present disclosure.

### DETAILED DESCRIPTION OF THE DISCLOSURE

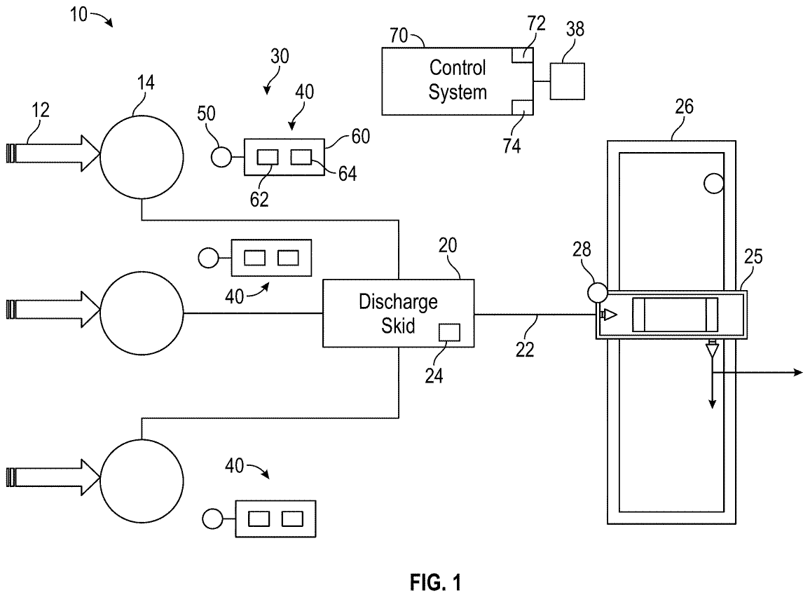

FIG. 1 schematically illustrates an automated system 30 for monitoring and draining sand from flowback equipment 14 in a sand management arrangement 10 for a flowback process. In general, the arrangement 10 is used for handling discharge of waste (i.e., slurry of sand or other solids and well fluids) to a tank 26 at a wellsite. In the present example, the arrangement 10 can handle flowback of sand and other solid particulate material in a slurry of flow from one or more wells at a wellsite. (For simplicity, the solid particulate of the flowback waste is referenced herein as “sand,” but it will be appreciated that the flowback can include a variety of other solid materials. Therefore, reference to sand, waste, solids, sludge, slurry, and the like can be used interchangeable as the case may be.)

As is typical, flowback 12 from well(s) (not shown) at the wellsite can be fed to flowback equipment 14, which can include cyclones, separators, filters, vessels, tanks, and the like. The flowback equipment 14 handles the sand contained in the flow 12 from the wells. To further handle the flowback, the arrangement 10 includes a discharge skid 20 for discharging sand from the upstream equipment 14 to a disposal tank 26 at the wellsite. The purpose of the tank 26 is to collect the sand, water and other waste dispersed by the upstream equipment 14 through controlled waste exhaustion by the discharge skid 20.

As shown, the discharge skid 20 connects by suction lines 16 to the upstream equipment 14 and connects by a discharge line 22 to a discharge module 25 disposed on the disposal tank 26. When operated, the discharge skid 20 discharges a slurry of sand and reduced liquid content from the upstream equipment 14 to the discharge module 25, which dumps the waste into the disposal tank 26. A controller 28 associated with the discharge module 25 can operate a flap or other metering components on the discharge module 25 so the discharge module 25 can be operated in conjunction with any pumps, valves, chokes, and the like on the discharge skid 20. Operations of the discharge skid 20, the discharge module 28, the controller 28 and the like can be automated as well and the automated operation can be integrated into the current automated system. Details related to automated operations of the discharge skid 20, the discharge module 28, the controller 28 and the like can be found in co-pending U.S. Appl. No. 63/152,480 filed 23 Feb. 2021 and entitled “Automated Waste Disposal System for Waste Tank at Wellsite.:

The automated system 30 monitors the upstream flowback equipment 14 to determine when discharge of the sand should be performed by the discharge skid 20. To solve the issue of when to empty the flowback equipment 14, the automated system 30 is a computer-vision based system that can determine the opportune/optimal time that the drainage or dump of sand from the flowback equipment 14 needs to happen. As will be appreciated, computer vision refers to the technology of enabling computing equipment to “see”. At an abstract level, the computer vision disclosed herein uses observed infrared images of the flowback equipment 14.

To do the monitoring, the automated system 30 includes imaging units 40 having the infrared-enabled cameras 50 capable of thermal imaging. The system 30 operates the cameras 50 to observe the flowback equipment 14, such as a vessel or sand trap. The thermal imaging cameras 50 can wirelessly “scans” or “sees” the inside of the upstream flowback equipment 14 using infra-red technology. Then, the system 30 in turn determines the concentration of solid material or sand pile in that equipment 14.

In particular and as disclosed in more detail below, the thermal-imaging technology of the cameras 50 can detect and measure temperature differences in the flowback equipment 14 accurately and can make these measurements from a distance, thus not being physically or directly connected to the upstream flowback equipment. The cameras 50 can distinguish and identify the various contents in the flowback equipment 14 based on the temperatures of those contents, being non-invasive in nature. Based on the thermal imaging, the system 30 measures the solids in the flowback equipment 14.

Depending on the size of the wellsite and the pieces of flowback equipment 14 present, the system 30 can include more than one imaging unit 40, each of which can include one or more cameras 50 configured to image infrared radiation of a piece of the flowback equipment 14.

The system 30 also includes processing equipment to control operations of the system 30 in conjunction with the discharge skid 20 of the sand management arrangement 10. The processing equipment can include local controllers 60 and a control unit 70. The local controller 60 can be local processing equipment associated with the imaging units 40 and can be used for image capture, detection, initial processing, and data communication. The control unit 70 can be remote processing equipment, such as associated with an edge server or the like, and can be used for analysis, final processing, data communication, and system control. Processing can thereby be partially distributed among elements of the system 30.

Communication equipment 64 and 74 between the control unit 70 and local units 60 can allow for the exchange of imaging information and other data. Communication equipment 24 is also provided on the discharge skid 20 for communication with the control unit 70. For example, the control unit 70 can include remote processing capabilities and communication equipment 74 that communicate with the communication equipment 64 of the local controller(s) 60 on the imaging units 40. The control unit 70 coordinates the operation of the imaging units 40 to image the flowback equipment 14. Based on the image information, the control unit 70 measures the amount of sand in the respective flowback equipment 14 and then controls the time when the sand is discharged from the equipment 14 to the tank 26 by the discharge skid 20. Through a dispatch system 38, the control unit 70 can further remotely coordinate the dispatching of other resources, such as vacuum trucks, personnel and the like, to equipment 14 need servicing or to the tanks 26 determined to be full.

One control unit 70 can be used with multiple imaging units 40 and can be remotely situated at the wellsite or elsewhere. Either way, wired or wireless communications can be used between the communication equipment 24, 64, 74 of the discharge skid 20, the local controllers 60, and the control unit 70.

In contrast to a manual process of dumping waste into a tank, the automated computer-vision system 30 operates with remote capabilities to schedule and execute operations. As discussed in more detail below, the system 30 can measure the sand in the flowback equipment 14 accurately based on thermal imaging and can synchronize start/stop operations of the discharge skid 20. Furthermore, because the automated system 30 uses image based detection through the infrared image capture and processing, the automated system 30 can be used with any existing equipment 14 and can be retrofitted as needed. No internal sensing equipment needs to be used with the equipment 14 because the automated system 30 is external to existing hardware and equipment. This makes the disclosed system 30 more readily usable with various forms of flowback equipment, but also greatly simplifies implementation, integration, and maintenance. No internal modifications to the equipment 14 are needed, which can compromise pressure containment and cause other issues. Moreover, the system 30 can be remotely actuated and can operate under a customizable schedule. These and other details are discussed below.

As generally shown, the infrared-enabled cameras 50 mount adjacent to the flowback equipment 14 to be filled with waste (i.e., sand). The local controller 60 uses computer vision processing on infrared images captured by the cameras 50 and in turn determines the “level” of semi-solids in the equipment 14. In the end, the system 30 can estimate the fill level of the flowback equipment 14. Based on the fill level, the system 30 can initiate the discharge skid 20 to automatically discharge waste to the disposal tank 26 and can notify operators at the opportune time to perform predictive maintenance (e.g., determining the tank fullness, notifying a clearance crew to clear the tank 26, etc.).

A given piece of flowback equipment 14 may have one or more cameras 50 associated with the equipment 14, and the cameras 50 can be mounted on one or more sides and at any vertical position along the equipment 14 so that filling of the equipment's volume can be imaged. Each camera 50 can be powered by a replaceable battery, a solar panel and rechargeable battery, or another type of power supply. The cameras 50 can be fixedly mounted relative to the equipment 14 or may be maneuverable using an appropriate mounting structure. In another arrangement, a given camera 50 may be used with several pieces of flowback equipment 14. In this case, any mounting structure for the camera 50 can be adjustable to direct the camera 50 to different ones or parts of the equipment 14 or different sides of the equipment 14.

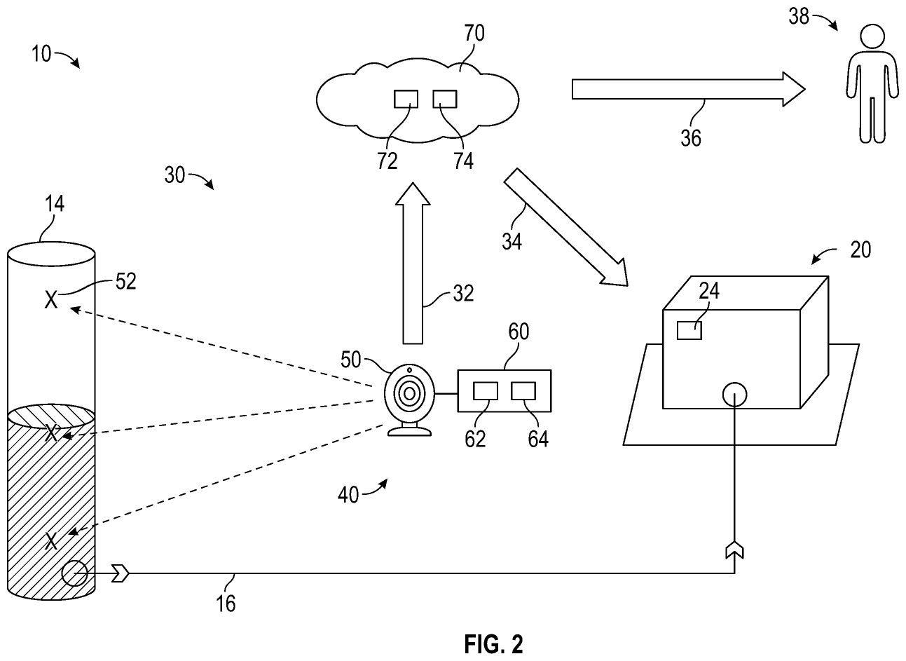

FIG. 2 illustrates a schematic view of portions of the automated drainage system 30 in more detail. Only some elements of the sand management arrangement 10 are shown, including the flowback equipment 14, such as a flowback vessel, connected by a suction line 16 to the discharge skid 20. The suction line 16 is used to draw the waste from the equipment 14.

As before, the automated drainage system 30 includes one or more imaging units 40 associated with one or more pieces of flowback equipment 14, such as the flowback equipment 14. In general, one or more imaging units 40 can be used for imaging the same equipment 14, such as from different viewpoints, sides, or the like. Also, one imaging unit 40 can image more than one piece of processing equipment 14 at the same time or in an alternative fashion.

In the present example, however, the imaging unit 40 includes one infrared-enabled camera 50 arranged to view a flowback equipment 14 (or portion thereof). The imaging unit 40 also include a local controller 60 having a processor 62 and communication equipment 64, which enable initial processing of captured image data, local communication of data between the cameras 50 of the units 40 at the wellsite, and remote communication of data between the imaging unit 40 and the remote processing equipment of the control unit 70.

In this particular implementation shown here, the control unit 70 can include one or more edge or cloud computers on a network and connected in communication with the imaging units 40. The infrared-enabled camera 50 images infrared radiation of the flowback equipment 14, such as by imaging the exterior of the equipment 14. Processing software monitors the temperatures from the infrared sensing. To simplify the processing, particular rangefinder points 52 are selected for the imaging data of the subject equipment 14. These rangefinder points 52 are selected for the particular equipment 14, the temperature values, the contents of the equipment 14, and other factors governed by the implementation at hand. The location of the rangefinder points 52 can be selected and calibrated based on the particular implementation (i.e., specific wellsite or model of flowback trap/upstream equipment).

The imaging unit 40 detects the separation or distribution of solids and liquids based on different temperatures and densities in the observed equipment 14. The local controller 60 processes signals captured by the camera 50 to determine a relatively precise evaluation of the sand accumulation condition (sand concentration or the density of sand slurry increase) at the outlet of the sand-separating equipment 14. If a determination concludes that enough sand has accumulated, the control unit 70 submits a drain signal to the discharge skid 20 so that a drainage and discharge operation is performed. The control unit 70 can obtain a feedback signal can from the imaging unit 40 and its camera 50 during the discharge operation so the operation of the discharge skid 20 can use a closed control loop. The discharge can continue until a certain threshold of the sand has been drained from the equipment 14. In the end, the determination of the amount of sand in the equipment 14 based on the imaging helps to correctly operate the discharge skid 20.

Communication pathways 32, 34, 36 are used between the components to coordinate operations. These communication pathways 32, 34, 36 can be one way links as shown, or can be two-way links for feedback and control. In general, these communication pathways 32, 34, and 36 can be wired or wireless communication links between the communication equipment 24, 64, 74. A first communication pathway 32 connects the imaging unit's communication equipment 64 to communication equipment 74 of the edge/cloud computers of the control unit 70. A second communication pathway 34 connects the control unit's communication equipment 74 to the communication equipment 24 of the discharge skid 20. Finally, a third communication pathway 36 connects the control unit 70 to a dispatch service 38, which can inform and dispatch remote operators, personnel, and the like.

During a flowback operation, the imaging unit 40 obtains infrared image information of the flowback equipment 14 using the infrared-enabled camera(s) 50 that image the equipment 14. In general and as already noted, the imaging unit 40 can image one piece of the flowback equipment 14 using one infrared-enabled cameras 50, or the imaging unit 40 can image the same piece of flowback equipment 14 using several of the infrared-enabled cameras 50. Further still, one imaging unit 40 can image more than one piece of the flowback equipment 14 using the infrared-enabled cameras 50 depending on the area of view and the arrangement of the flowback equipment 14.

The local controller 60 monitors temperature values at a plurality rangefinder points 52 in the infrared image information obtained by the cameras 50. For example, the rangefinder points 52 are selected at appropriate locations (e.g., vertical heights) on the flowback equipment 14 relative to the dimensions of the flowback equipment 14 so the contents in the equipment's volume can be estimated. Due to the various conditions at the wellsite, the different types of flowback equipment 14 used, etc., the temperature values for the rangefinder locations 52 can be calibrated based on a number of factors, such as those associated with the flowback equipment, the slurry, and ambient conditions.

Based on the monitored temperature values, the local controller 60 determines a demarcation between the solid particulate and the liquid in the flowback equipment 14. To determine the demarcation, the local controller 60 can determine that the temperature value at one or more upper ones of the rangefinder points 52 meets a threshold value indicative of the liquid and can determine that the temperature value at one or more lower ones of the rangefinder points 52 meets a threshold indicative of the solid particulate. The liquid is expected to have a high temperature compared to the solid particulate, which is expected to settle at the base of the equipment 14. The demarcation can be established between the upper and lower contiguous rangefinder points 52. Resolution of the determination can depend on the temperature thresholds and the number of rangefinder points 52 used. These and other variables can be configured for a particular implementation.

This demarcation can then be sent to the control unit or edge server 70, which then estimates from the demarcation an amount of the equipment's volume filled by the solid particulate. Based on the estimated amount of solids, the control unit 70 instructs the discharge skid 20 to discharge the flowback equipment 14. For example, the control unit 70 instruct the discharge skid 20 to open valves and activate pump(s) to pump the slurry from the flowback equipment 14 to the waste tank (26; FIG. 1). The remote processing unit 70 can also send a communication to the dispatch service 38 for remote operators, personnel, and the like associated with the wellsite.

As noted, the processing equipment for the system 30 can include the local controller 60 and the centralized control unit 70 disposed in communication via communication equipment 64, 74. In general, the communications can include wired or wireless communication suited for a wellsite environment. Possible wireless communications include satellite, cellular, and Wi-Fi communications. One edge server at the control unit 70 can manage multiple imaging units 40 at one wellsite and can likewise manage the drainage at multiple wellsites.

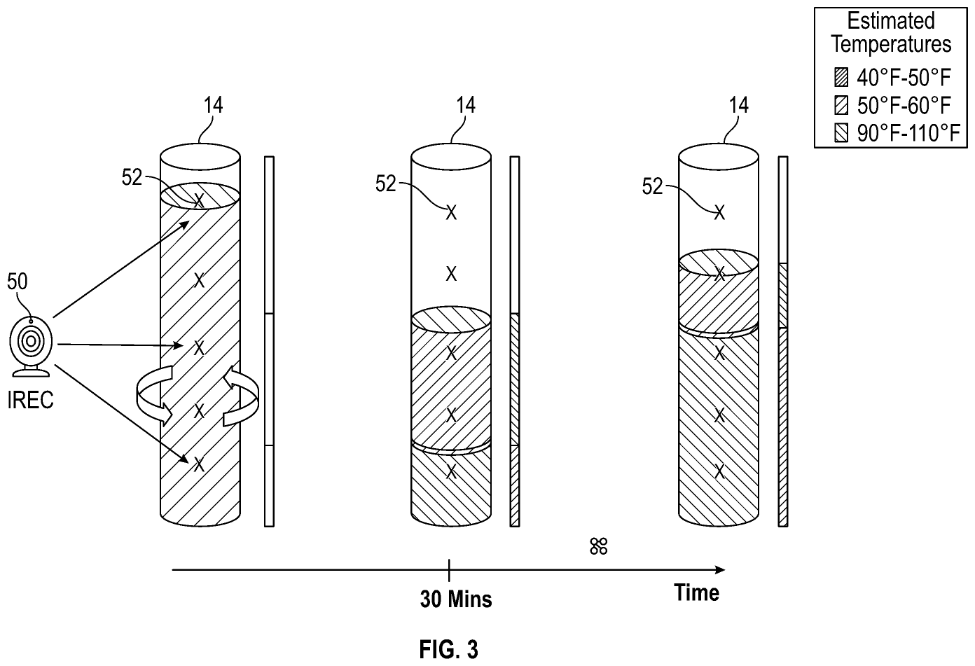

FIG. 3 illustrates a schematic view of infrared measurements of the automated system 30 in determining when to discharge sand from flowback equipment 14, such as a vessel. As shown, the infrared-enabled camera 50 of an imaging unit 40 is arranged to obtain imaging information from the flowback equipment 14. As noted previously, the image processing of the imaging information can analyze various defined rangefinder points 52 relative to the flowback equipment 14.

Using these points 52, the image processing can determine the difference in temperature due to different contents inside the flowback equipment 14. As initially shown, slurry newly introduced to the flowback equipment 14 may be relatively uniform along the vertical height of the flowback equipment 14. Overtime, the contents of the flowback equipment 14 begin to settle, and a sand pile begins to form at the bottom of the flowback equipment 14 due to gravity. Liquid content begins settling on top of the sand pile. The different contents separated at these different vertical heights in the equipment 14 produce different temperatures, which are imaged by the camera 50. As the temperature distribution changes with the increased filling of the equipment 14 and settling of the sand pile (especially relative to the rangefinder points 52), the image processing of the image data from the camera 50 can estimate the demarcation of the sand pile and liquid in the equipment 14. In turn, further processing especially by the control unit 70 can recommend and control drainage of the equipment 14 when necessary.

The flowback equipment 14 shown here in FIG. 3 can be a piece of flowback equipment, such as a triple cyclonic 10k/15k centrifugal chamber. Liquids (such as chemical water, normal water, oil), gas and sand flow into the equipment 14 during flowback operations. After some time, e.g., approximately 30 minutes later, the sand and solid particles start settling at the bottom of the flowback equipment 14. As time goes on, this settling continues. Eventually, the demarcation between the solid and the liquid is quite defined. Thus, the temperature gradient is expected to be sharp and not gradual over the vertical height of the equipment 14. Based on the infrared images of the equipment 14, the image processing can detect a delta (jump or drop) of temperature over the height of the equipment 14 between the rangefinder points 52. The liquid temperature will be higher than the sand pile.

The temperatures at the rangefinder points 52 indicate the demarcation of the sand pile and liquid levels. As will be appreciated, the rangefinder points 52 can be set up as needed throughout the vertical height of the vessel's chamber and can be situated as best suited for the type of equipment 14, the contents to be held, and other factors for the implementation at hand. As certain levels in the equipment 14 are crossed and/or as certain temperature thresholds at the rangefinder 52 points are met, the imaging processing can determine the “level” of sand in the equipment 14. Then, in the distributed processing, the control unit 70 can best determine how or when to discharge the contents from the equipment 14 so appropriate timing for the discharge by the discharge skid 20 can be adjusted.

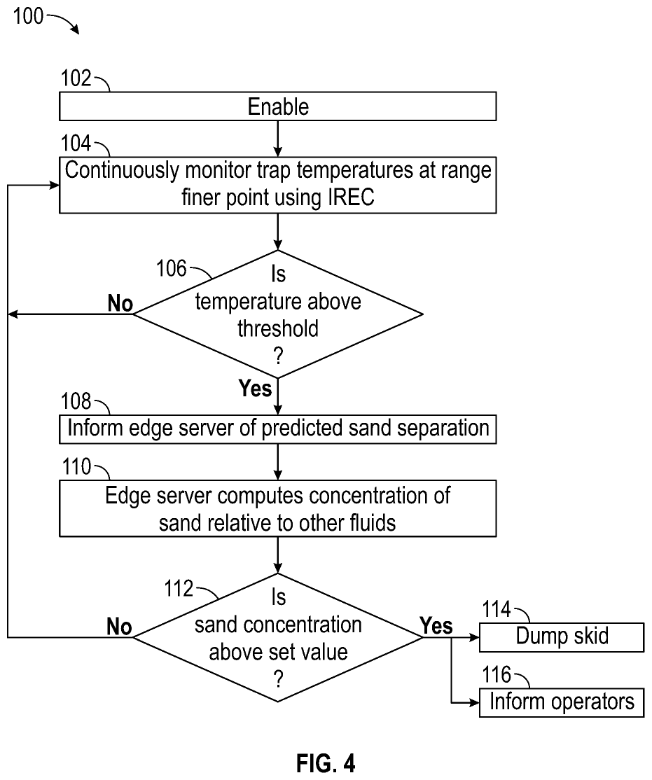

Having a detailed understanding of the automated system 30, discussion now turns to FIG. 4, which illustrates a process 100 of operating the automated drainage system 30. Reference to elements in the other figures is provided for better understanding.

Operations of the automated system 30 are initially enabled (Block 102). Enabling the system 30 may depend on the operation of the sand management arrangement 10, such as the produced capacity of the flowback equipment 14, measured flow rates and pressure, and/or operations of the discharge skid 20.

When the system 30 is enabled and the flowback arrangement 10 operates, the imaging units 40 continuously monitor the temperatures at the rangefinder points 52 on the flowback equipment 14 using the cameras 50 (Block 104).

The local controller 60 at the imaging units 40 can monitor whether the temperatures at the rangefinder points 52 are above defined thresholds as noted above (Decision 106). If not, the imaging units 40 can continue monitoring the flowback equipment 14 until defined threshold are reached (or the automated system 30 is manually overridden to activate).

The local controller 60 can eliminate erroneous signals in the thermal imaging and noises through filtering and signal processing. For example, the local controller 60 and camera 50 can be calibrated to factor out parameters related to environmental temperatures, velocities of fluid, oil/gas influences, and the like. This calibration can be programmed through self-learning and expanding the database with experimental data. In the end, the evaluation of the amount of sand can become more and more precise so a more accurate discharge time and duration can be used. Accordingly, the control unit 70/local controller 60 can use machine learning algorithms.

Once certain threshold temperatures are reached, the local controller 60 communicates the information to the edge server of the control unit 70 (Block 108). The information gives the edge server a prediction of the sand separation (i.e., the demarcation between the sand pile and liquid). Thus, when the temperature changes above a threshold at these rangefinder points 52, the imaging unit 40 informs the control unit 70 via the cloud or other network that such an event has occurred. In the physical world, this means the concentration of sand relative to other sludge materials has reached a benchmark value in the flowback equipment 14.

In turn, the edge server of the control unit 70 computes a concentration of sand relative to other fluids in the flowback equipment 14 (Block 110) and determines whether the sand concentration for that equipment 14 is above a set value (Decision 112). The control unit 70 can include a database of sand slurry densities, temperatures, and the IR spectrum based on experiments and experience to make these determination.

If the current level of sand is not above the threshold, then the operations can continue with sustained and continuous imaging and monitoring. If the set threshold value is reached, the control unit 70 can communicate with the discharge skid 20 to dump the contents (Block 114). At the same time, the control unit 70 can inform operators that the flowback equipment 14 is full or can communicate other information to a dispatch service 38 (Block 116).

A computer algorithm of the control unit 70 can make these determinations—not only based on current data, but also based on historical data as well as when the equipment 14 was last emptied to determine if drainage should be initiated. If so, the control unit 70 initiates discharge by the discharge skid 20 and connected equipment.

As noted, the control unit 70 (or the local controller 60) determines the current level of the sand pile in the equipment 14. To ensure proper emptying of the equipment 14, the control unit 70 (or the local controller 60) determines if the sand level is above a defined and stored threshold, which depends on the size of the equipment 14 and other factors. Based on the level sensing capacity of the imaging units 40 and other components, the drainage system 30 can determine how full the vessel 18 is. This allows the automated system 30 to determine proper drainage times for the equipment 14. The arrangement also allows the system 30 to perform predictive maintenance, such as notifying a clearance crew pre-emptively so their time of arrival and clearance of the waste 26 is optimized. These factors also different between operators—i.e., some operators may want the traps emptied at 25% full, while others may want to wait till 75%. Accordingly, the system can adapt to preset configurations at setup and can be easily customized to the operators' needs.

The control unit 30 (or the local control 50) can notify any appropriate operator via the dispatch service 38. As part of that contact, any available vacuum truck nearest to the wellsite can be contacted through remote and automated communications to perform maintenance of the equipment 14 or to empty the waste tank 26. For example, the control unit 30 can predict the optimal time to discharge based on the vision-based analysis, and the control unit 30 can also cascade requests for maintenance operations.

In sending a command to the discharge skid 20, the control unit 70 can also initiate the operation of any flap or other components on the discharge module 25. Either way, the control unit 70 enables actuation of (or actively actuates) the discharge skid 20 to discharge the sludge and waste of sand to the discharge module 25 on the tank 26. Once complete, the drainage system 30 can return to monitoring the equipment 14 until needed for another drainage operation.

During operations, the drainage system 30 can operate with synchronized starting/stopping with the other processes of the sand management arrangement 10. There are several upstream flowback equipment 14 that facilitate the final step of dumping sand in the tank 18. Operation of the entire arrangement 10 depends a great deal on the quality and quantity of ingredients that flow out through the feed pipes. Therefore, the operation of the automated system 30 may be different on every run, e.g. depending on the amount of sand to dump, what is the concentration of sand in the discharge, what flow pressures are present, etc.

The control unit 70 in conjunction with the local controller 60 can operate under a customizable timing scheme or schedule. Scheduling can set when the imaging unit 40 should acquire imaging information and/or when the information should be communicated. Either way, the control unit 70 communicates remotely with the imaging units 40 for the equipment 14 to determine the optimal time to discharge by the discharge skid 20. Accordingly, the timing mechanism of the system 39 can drive the discharge at the appropriate time. If practical, the discharge could still be run on a scheduled basis.

Being able to actively determine when to drain the flowback equipment 14 according to the present disclosure has a number of advantages over simply using a preset period. In particular, the automated system 30 can improve equipment lifetimes. Assume that a program-controlled sand drainage skid, due to unavailability of sand data, is set to be operated every hour. Then for a whole month of operation, each isolation valve in the system has to be operated 24×30=720 cycles. Now consider the choke valve operating time, suppose each cycle is 3 mins, which in total accounts to 2160 minutes in duration. If the isolation valve has a life cycle of 300 cycles and a choke has a life time of 20 hours (1200 mins), the isolation valve would need to be replaced twice and the choke needs to also be replaced twice. This is costly in terms of valves, especially the choke valve, and the engineering time in parts supply chain, assembly and machine maintenance.

By employing the automated system 30, the sand estimation can be more accurately evaluated. The system 30 may reduce the drainage operating to a more appropriate time period (e.g., every 4-6 hours), such as when the sand concentration at the vessel drainage outlet area is close to 80% of sand. In that case, the automated system 30 can run at fewer cycles, which can increase the lifespan of equipment, such as the total isolation valve and choke.

In another advantage, the automated system 30 reduces energy consumption. For example, if the energy consumption of each drainage cycle (defined as one cycle of a drain skid operation) is 0.12 KwH, then using the system 30 with the discharge skid 20 can result in total energy savings of (720−120)×0.12 kWH=72 kWH.

Additionally, the monitoring by the automated system 30 optimizes predictive maintenance of the flowback equipment 14 by knowing the optimal time to dump using the computer-vision based system. The automated system 30 determines when and where to deploy resources. Given the automated system 30 can dump sand based on measurement of how much sand needs to be dumped, a roving crew's job will be much easier because they do not need to reach a site in real time to initiate a trap dump.

Finally, the automated system 30 is easy to deploy and install in field at a wellsite. Usually, two human laborers are required every hour to manually discharge and dump waste for sand management arrangements 10 that do not have a timing mechanism. With timing offered by the automated system 30, any such continuous or repeated deployment of resources is not necessary because the automated system 30 can accurately understand and initiate a dump by the discharge skid 20 automatically.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, it is intended that the disclosed embodiments include all modifications and alterations to the full extent that they come within the scope of the above-details or the equivalents thereof.

What is claimed is:

1. A method of monitoring flowback equipment that receives discharge slurry of liquid and solid particulate at a wellsite, the method comprising:
obtaining infrared image information of the flowback equipment using one or more infrared-enabled cameras;
monitoring temperature values at a plurality rangefinder points in the infrared image information;
determining a demarcation between the solid particulate and the liquid in the flowback equipment based on the monitored temperature values;
estimating from the demarcation an amount of the flowback equipment filled by the solid particulate; and
instructing drainage of the flowback equipment based on the estimated amount.

2. The method of claim 1, wherein obtaining the infrared image information of the flowback equipment using the one or more infrared-enabled cameras comprises:
imaging each piece of the flowback equipment using one of the one or more infrared-enabled cameras;
imaging a same piece of the flowback equipment using a plurality of the one or more infrared-enabled cameras; or imaging more than one piece of the flowback equipment using the one or more infrared-enabled cameras.

3. The method of claim 1, wherein obtaining the infrared image information and monitoring the temperature values at the plurality rangefinder points in the infrared image information comprises selecting the rangefinder points at locations on the flowback equipment relative to dimensions of the flowback equipment.

4. The method of claim 3, wherein monitoring the temperature values at the plurality rangefinder points in the infrared image information comprises calibrating the temperature values for the rangefinder locations based on factors associated with the flowback equipment, the slurry, and ambient conditions.

5. The method of claim 1, wherein determining the demarcation between the solid particulate and the liquid in the flowback equipment based on the monitored temperature values comprises:
determining that the temperature value at one or more first of the rangefinder points meets a threshold value indicative of the liquid; and
determining that the temperature value at one or more second of the rangefinder points meets a threshold indicative of the solid particulate; and
establishing the demarcation between the first and second contiguous rangefinder points.

6. The method of claim 1, wherein estimating from the demarcation the amount of the flowback equipment filled by the solid particulate comprises calculating, based on the demarcation and dimensions of the flowback equipment, what volume of the flowback equipment is filled by the solid particulate.

7. The method of claim 1, wherein instructing the drainage of the flowback equipment based on the estimated amount comprises instructing a discharge skid to pump the slurry from the flowback equipment to a waste tank.

8. The method of claim 7, further comprising sending a communication to a dispatch service for personnel associated with the wellsite.

9. The method of claim 1, wherein the steps of obtaining the infrared image information and monitoring the temperature values and determining the demarcation comprises:
processing the image information locally at a local processing unit associated with the one or more infrared-enabled cameras; and
communicating the demarcation to a remote control unit.

10. The method of claim 9, wherein the steps of estimating and instructing drainage comprises:
receiving the communication of the demarcation at the remote control unit;
processing the demarcation; and
sending an instruction from the remote processing unit to a discharge skid at the wellsite.

11. A system used with flowback equipment at a wellsite, the system comprising:
one or more cameras configured to image infrared radiation of the flowback equipment;
communication equipment configured to communicate information; and
processing equipment disposed in communication with the one or more cameras and the communication equipment, the processing equipment being configured to:
obtain infrared image information of the flowback equipment using the one or more infrared-enabled cameras;
monitor temperature values at a plurality rangefinder points in the infrared image information;
determine a demarcation between the solid particulate and the liquid in the flowback equipment based on the monitored temperature values;
estimate from the demarcation an amount of the flowback equipment filled by the solid particulate; and
instruct drainage of the flowback equipment based on the estimated amount.

12. The system of claim 11, wherein to obtain the infrared image information of the flowback equipment using the one or more infrared-enabled cameras, the processing equipment is configured to:
image each piece of the flowback equipment using one of the one or more infrared-enabled cameras;
image a same piece of the flowback equipment using a plurality of the one or more infrared-enabled cameras; or
image more than one piece of the flowback equipment using the one or more infrared-enabled cameras.

13. The system of claim 11, wherein to monitor the temperature values at the plurality rangefinder points in the infrared image information, the processing equipment is configured to select the rangefinder points at locations on the flowback equipment relative to the dimensions of the flowback equipment.

14. The system of claim 13, wherein to monitor the temperature values at the plurality rangefinder points in the infrared image information, the processing equipment is configured to calibrate the temperature values for the rangefinder locations based on factors associated with the flowback equipment, the slurry, and ambient conditions.

15. The system of claim 11, wherein to determine the demarcation between the solid particulate and the liquid in the flowback equipment based on the monitored temperature values, the processing equipment is configured to:
determine that the temperature value at one or more first of the rangefinder points meets a threshold value indicative of the liquid; and
determine that the temperature value at one or more second of the rangefinder points meets a threshold indicative of the solid particulate; and
establish the demarcation between the first and second contiguous rangefinder points.

16. The system of claim 11, wherein to estimate from the demarcation the amount of the volume filled by the solid particulate, the processing equipment is configured to calculate, based on the demarcation and dimensions of the flowback equipment, what volume of the flowback equipment is filled by the solid particulate.

17. The system of claim 11, wherein to instruct the drainage of the flowback equipment based on the estimated amount, the processing equipment is configured to instruct a discharge skid to pump the slurry from the flowback equipment to a waste tank.

18. The system of claim 17, wherein the processing equipment is further configured to send a communication to a dispatch service for personnel associated with the wellsite.

19. The system of claim 11, wherein the processing equipment comprises a local processing unit and a remote processing unit in communication via the communication equipment; and wherein to monitor the temperature values and determine the demarcation, the processing equipment is configured to:
process the image information locally at a local processing unit associated with the one or more infrared-enabled cameras; and
communicate the demarcation to a remote processing unit.

20. The system of claim 19, wherein to estimate and instruct the drainage, the processing equipment is configured to:
receive the communication of the demarcation at the remote processing unit;
process the demarcation; and
send an instruction from the remote processing unit to a discharge skid at the wellsite.
